(19) United States
(12) Patent Application Publication
(10) Pub. No.: US 2007/0000519 A1
(43) Pub. Date: Jan. 4, 2007

(54) Removal of residues for low-k dielectric materials in wafer processing

(76) Inventors: Gunilla Jacobson, Menlo Park, CA (US); Subramanyam A. Iyer, Bangalore (IN)

Correspondence Address: HAVERSTOCK & OWENS LLP, 162 NORTH WOLFE ROAD, SUNNYVALE, CA, 94086, US

(21) Appl. No.: 11/174,256

(22) Filed: Jun. 30, 2005

(51) Int. Cl. B08B 3/04

(52) U.S. Cl. 134/21; 134/26; 134/34

(57) ABSTRACT

A method of removing post-etch residue from a patterned low-k dielectric layer is disclosed. The low-k dielectric layer preferably comprises a porous silicon oxide-based material with the post-etch residue thereon. The post-etch residue is a polymer, a polymer contaminated with an inorganic material, an anti-reflective coating and/or a combination thereof. In accordance with the method of the invention, the post-etch residue is removed from a patterned low-k dielectric layer using a supercritical cleaning solution comprising supercritical carbon dioxide pyridine-hydrogen fluoride adducts, pyridine, hydrogen fluoride and combination thereof

### CROSS-REFERENCE TO RELATED APPLICATIONS

This patent application is related to commonly owned co-pending U.S. patent application Ser. No. 10/321,341, filed Dec. 16, 2002, entitled “FLUORIDE IN SUPERCRITICAL FLUID FOR PHOTORESIST AND RESIDUE REMOVAL” and the commonly owned co-pending U.S. patent application Ser. No. 10/442,557, filed May 20, 2003, entitled “TETRA-ORGANIC AMMONIUM FLUORIDE AND HF IN SUPERCRITICAL FLUID FOR PHOTORESIST AND RESIDUE REMOVAL” which is hereby incorporated by reference in its entirety.

### FIELD OF THE INVENTION

The present invention relates to the field of processing porous low-k dielectric materials used in the processing of semiconductor wafer. More particularly, the present invention relates to the field of processing porous low-k dielectric materials using a supercritical cleaning solution.

### BACKGROUND OF THE INVENTION

Semiconductor fabrication generally uses photoresist in etching and other processing steps. In the etching steps, a photoresist masks areas of the semiconductor substrate that are not etched. Examples of the other processing steps include using a photoresist to mask areas of a semiconductor substrate in an ion implantation step or using the photoresist as a blanket protective coating of a processed wafer or using the photoresist as the blanket protective coating of a MEMS (micro electromechanical system) device.

State of the art integrated circuits can contain up to 6 million transistors and more than 800 meters of wiring. There is a constant push to increase the number of transistors on wafer-based integrated circuits. As the number of transistors is increased, there is a need to reduce the cross-talk between the closely packed wires in order to maintain high performance requirements. The semiconductor industry is continuously looking for new processes and new materials that can help to improve the performance of wafer-based integrated circuits.

### SUMMARY OF THE INVENTION

The present invention is directed to a method of and system for removing siloxane-based material from a substrate with a supercritical cleaning solution. In accordance with the embodiments of the present invention, a supercritical cleaning solution is generated which comprises supercritical CO2 and an amount of pyridine-hydrogen fluoride and a carrier solvent, such as N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate and alcohol to help introduce the pyridine-hydrogen fluoride into the supercritical CO₂. Further details of supercritical systems suitable for cleaning post-etch residues from wafer substrates are described in U.S. patent application Ser. No. 09/389,788, filed Sep. 3, 1999, and entitled “REMOVAL OF PHOTORESIST AND PHOTORESIST RESIDUE FROM SEMICONDUCTORS USING SUPERCRITICAL CARBON DIOXIDE PROCESS” and U.S. patent application Ser. No. 09/697,222, filed Oct. 25, 2000, and entitled “REMOVAL OF PHOTORESIST AND RESIDUE FROM SUBSTRATE USING SUPERCRITICAL CARBON DIOXIDE PROCESS”, both of which are hereby incorporated by reference herein.

In accordance with one embodiment, a supercritical cleaning solution comprising pyridine and hydrogen fluoride. The supercritical cleaning solution is circulated around the substrate structure, subjected to a plurality of depression/compression cycles and is then the supercritical cleaning solution is vented away from the substrate structure carrying the removed residues along with the supercritical cleaning solution. After the substrate structure is treated with a cleaning solution, the substrate structure can be treated with a supercritical rinsing solution.

In one method of the invention, a substrate and/or substrate structure comprises a sacrificial light-absorbing material (SLAM) that has been used for via filling during dual damascene processing. SLAM can be applied using spin coating and standard baking operations.

SLAM materials have excellent gap-fill capabilities, exhibit high absorptions of light at the exposure wavelength (248 nm), have comparable dry etch rates to interlayer dielectrics (ILDs), have good etch selectivity to photoresist, and are compatible with standard lithographic processes. Intel has patented SLAM materials and the method of manufacturing SLAM materials.

Briefly, SLAM materials can be synthesized by adding dye to a member of the siloxane-based family of spin on glass (SOG). A SLAM material is typically deposited after via cleaning steps and is followed by trench patterning steps. The SLAM material provides for a more forgiving etch process that results in optimized trench profiles and better trench depth uniformity. SLAM provides an inorganic film that prevents shell defects and etches at substantially the same rate as the ILD.

### BRIEF DESCRIPTION OF THE DRAWINGS

A more complete appreciation of various embodiments of the invention and many of the attendant advantages thereof will become readily apparent with reference to the following detailed description, particularly when considered in conjunction with the accompanying drawings, in which:

FIG. 1A shows a pyridine structure used to form an organic hydrogen fluoride source, in accordance with an embodiment of the invention;

FIG. 1B shows an organic hydrogen fluoride source in equilibrium with an ammonium hydrogen fluoride adduct, in accordance an embodiment of the invention.

FIG. 2 shows an exemplary block diagram of a processing system, in accordance with an embodiment of the present invention;

FIG. 3 is a plot of pressure versus time for a supercritical cleaning, rinse or curing processing step, in accordance with an embodiment of the invention;

FIG. 4 is a schematic block diagram outlining steps for removing a residue from a patterned low-k layer, in accordance with an embodiment of the invention; and

FIG. 5 shows scanning electron microscope (SEM) images of a wafer with low-k patterned low-k structures both before and after treatment with a supercritical cleaning solution, in accordance with an embodiment of the invention.

### DETAILED DESCRIPTION OF SEVERAL EMBODIMENTS

The term low-k materials, generally, refers to materials exhibiting low dielectric constants (2.5 or below). Low-k materials have been shown to reduce cross talk and provide a transition into the fabrication of small integrated circuit geometries. Low-k materials have also proven useful for low temperature processing. For example, spin-on-glass materials (SOG) and polymers can be coated onto a substrate and treated or cured at relatively low temperature to make porous silicon oxide-based low k layers.

While low-k materials are promising materials for fabrication of advanced microcircuitry, they also provide several challenges. For example, they are not always compatible with other wafer fabrication steps, and they tend to be less robust.

Generally, to obtain the high resolution line widths and high feature aspect ratios in a wafer etch process, an anti-reflective coating is required. In earlier processes, an anti-reflective coating (ARC) is vapor deposited on the dielectric layer. For example, the anti-reflective coating can comprise a nitride layer, such as a titanium nitride (TiN), which is not removed after etching the dielectric layer but instead remains part of the transistor. Because nitrides are high dielectric materials, they are not well suited for use as anti-reflective coatings on low-k materials, as the high dielectric properties of a nitride layer can dominate the electrical properties. Accordingly, a silicon oxide-based anti-reflective coating can be used, and the silicon oxide anti-reactive coating can be removed from the low-k layer in a post-etch process. However, the low-k layer can be extremely sensitive to chemical treatment and as a result can be damaged by the chemical post-etch treatments required to remove the anti-reflective coating.

A further problem can arise when the low-k layer is doped through a photoresist mask using ion implantation. Ion implantation through a mask can result in inorganic contaminants that are embedded in the polymeric mask. These inorganic contaminants can render the photoresist difficult to remove. In addition, following an etching step, the remaining photoresist tends to exhibit a hardened character even without inorganic contaminants making the photoresist difficult to remove. Accordingly, the hardened residue has often required aggressive chemistries to be thoroughly removed.

A number of techniques and systems have been developed, which utilize supercritical solutions for cleaning wafers in a post-etch cleaning process. While these processes show considerable promise for cleaning post-etch residues from substrates, some of the cleaning chemistries used are too aggressive to be used to remove post-etch residue from low-k layers.

The invention provides a cleaning chemistry that is suitably selective to remove post-etch residues from low-k layers without causing significant damage or degradation to a pattern on the low-k layer. The cleaning chemistries used are suitable for removing polymer residues. For example, the polymer residues can include photoresist polymers, spin-on ARC polymers, or polymers containing inorganic contaminants, or combinations of two or more thereof. Inorganic contaminants can include boron, arsenic, phosphorus, and/or metal contaminants.

In one embodiment, a supercritical cleaning solution can include an organic-fluoride source, and the organic-fluoride source can include a pyridine structure that is capable of forming hydrogen fluoride adducts. In addition, the fluoride source can further include an ammonium salt and one or more carrier solvents that help control the concentrations of fluoride and hydrogen fluoride within the supercritical cleaning solution, as described in detail below.

Generally, during wafer processing the photoresist is placed on the wafer to mask a portion of the wafer in a preceding semiconductor fabrication process step such as an etching step. In the etching step, the photoresist masks areas of the wafer that are not etched while the non-masked regions are etched. In the etching step, the photoresist and the wafer are etched, producing etch features while also producing the photoresist residue and the etch residue. Etching the photoresist produces the photoresist residue. Etching the low-k features produces the etch residue. The photoresist and etch residues generally coat the sidewalls of the etched features.

In some etching steps, the photoresist is not etched to completion so that a portion of the photoresist remains on the wafer following the etching step. In these etching steps, the etching process hardens remaining photoresist. In other etching steps, the photoresist is etched to completion so that no photoresist remains on the wafer after such etching steps. In the latter case only the residue, that is the photoresist residue and the etch residue, remains on the wafer.

The invention is directed to removing photoresist for 0.25 micron and smaller geometries. In other words, the present invention is preferably directed to removing I-line exposed photoresists and smaller wavelength exposed photoresists. These are UV, deep UV, and smaller geometry photoresists. Alternatively, the present invention may be directed to removing larger geometry photoresists.

While the present invention is described in relation to applications for removing post-etch residue material typically used in wafer processing, it will be clear to one skilled in the art that the present invention can be used to remove any number of different residues (including polymers and oil) from any number of different materials (including silicon nitrides) and structures, including micro-mechanical, micro-optical, micro-electrical structures, and combinations thereof.

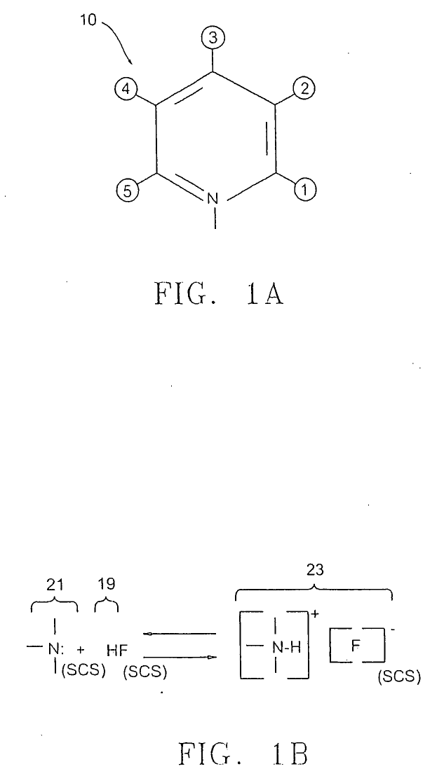

Referring now to FIG. 1A, in accordance the embodiments of the invention a cleaning solution comprises a heterocyclic nitrogen structure, such as pyridine structure 10, which can have organic groups attached to any one of the positions 1-5. The supercritical cleaning solution also preferably comprises hydrogen fluoride 19 (FIG. 1B).

Now referring to FIG. 1B, the pyridine structure 21 and the hydrogen fluoride 19 are used in a supercritical cleaning solution to form an adduct structure 23, which is similar to a salt structure and can be used to provide a controlled amount of free hydrogen fluoride 19 within the supercritical cleaning solution. In the illustrated embodiment, a tertiary amine is shown, but this is not required for the invention.

In further embodiments of the invention, a supercritical cleaning solution includes an amount of an ammonium or another ammonium structure, an ammonium salt, a fluoride salt and/or excess hydrogen fluoride to further control the concentration of free hydrogen fluoride 19 and/or fluoride ions within a supercritical cleaning solution.

Preferably, the supercritical cleaning chemistry, such as schematically illustrated in FIG. 1B, is introduced into supercritical carbon dioxide with one or more carrier solvents. A carrier solvent can also help to dissolve or remove residue from a substrate material in the cleaning process. Suitable carrier solvents include, but are not limited to, N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate, alcohols (such a methanol, ethanol and 2-propanol) and combinations thereof.

The present invention is particularly well suited for removing siloxane-based material from a substrate and even more specifically is well suited to removing SLAM and SLAM residues from a substrate.

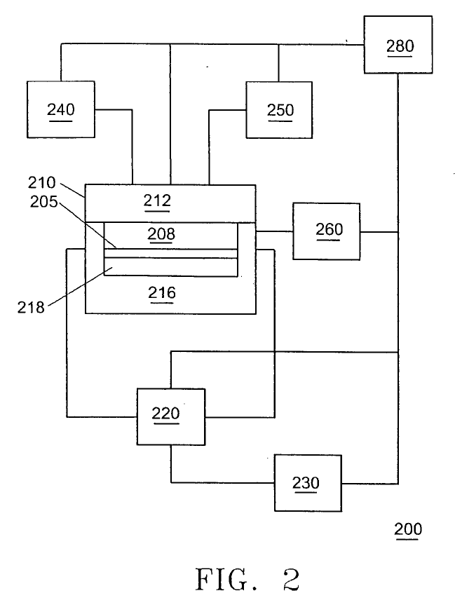

FIG. 2 shows an exemplary block diagram of a processing system in accordance with an embodiment of the invention. In the illustrated embodiment, processing system 200 comprises a processing module 210, a recirculation system 220, a process chemistry supply system 230, a carbon dioxide supply system 240, a pressure control system 250, an exhaust system 260, and a controller 280. The processing system 200 can operate at pressures that can range from 1000 psi. to 10,000 psi. In addition, the processing system 200 can operate at temperatures that can range from 40 to 300 degrees Centigrade.

The controller 280 can be coupled to the processing module 210, the recirculation system 220, the process chemistry supply system 230, the carbon dioxide supply system 240, the pressure control system 250, and the exhaust system 260. Alternately, controller 280 can be coupled to one or more additional controllers/computers (not shown), and controller 280 can obtain setup and/or configuration information from an additional controller/computer (not shown).

In FIG. 2, singular processing elements (210, 220, 230, 240, 250, 260, and 280) are shown, but this is not required for the invention. The semiconductor processing system 200 can comprise any number of processing elements having any number of controllers associated with them in addition to independent processing elements (210, 220, 230, 240, 250, 260, and 280).

The controller 280 can be used to configure any number of processing elements (210, 220, 230, 240, 250, and 260), and the controller 280 can collect, provide, process, store, and display data from processing elements. The controller 280 can comprise a number of applications for controlling one or more of the processing elements. For example, controller 280 can include a graphical user interface (GUI) component (not shown) that can provide easy to use interfaces that enable a user to monitor and/or control one or more processing elements of the processing system.

The processing module 210 can include an upper assembly 212, a frame 214, and a lower assembly 216. The upper assembly 212 can comprise a heater (not shown) for heating the process chamber, the substrate 205, or the processing fluid, or a combination of two or more thereof. Alternately, a heater is not required. The frame 214 can include means for flowing a processing fluid through the processing chamber 208. In one example, a circular flow pattern can be established, and in another example, a substantially linear flow pattern can be established. Alternately, the means for flowing can be configured differently. The lower assembly 216 can comprise one or more lifters (not shown) for moving a chuck 218 and/or the substrate 205. Alternately, a lifter is not required.

In one embodiment, the processing module 210 can include a holder or chuck 218 for supporting and holding the substrate 205 while processing the substrate 205. The stage or chuck 218 can also be configured to heat or cool the substrate 205 before, during, and/or after processing the substrate 205. Alternately, the processing chamber 210 can include a platen (not shown) for supporting and holding the substrate 205 while processing the substrate 205.

A transfer system (not shown) can be used to move a substrate 205 into and out of the processing chamber 208 through a slot (not shown). In one example, the slot can be opened and closed by moving the chuck 218, and in another example, the slot can be controlled using a gate valve (not shown).

The substrate 205 can include semiconductor material, metallic material, dielectric material, ceramic material, or polymer material, or a combination of two or more thereof. The semiconductor material can include Si, Ge, Si/Ge, or GaAs. The metallic material can include Cu, Al, Ni, Pb, Ti, Ta, or W, or combinations of two or more thereof. The dielectric material can include Si, O, N, or C, or combinations of two or more thereof. The ceramic material can include Al, N, Si, C, or O, or combinations of two or more thereof.

The recirculation system 220 can comprise one or more valves for regulating the flow of a supercritical processing solution through the recirculation system 220 and through the processing module 210. The recirculation system 220 can comprise any number of back-flow valves, filters, pumps, and/or heaters (not shown) for maintaining a supercritical processing solution and flowing the supercritical process solution through the recirculation system 220 and through the processing module 210 and the processing chamber 208.

In the illustrated embodiment shown in FIG. 2, the chemistry supply system 230 is coupled to the recirculation system 220, but this is not required for the invention. In alternate embodiments, the chemical supply system 230 can be configured differently and can be coupled to different elements in the processing system 200.

The chemistry supply system 230 can comprise a cleaning chemistry assembly (not shown) for providing cleaning chemistry for generating supercritical cleaning solutions within the processing chamber 208. The cleaning chemistry can include a fluoride source. For example, the fluoride source can include fluoride salts (such as ammonium fluoride salts), hydrogen fluoride, fluoride adducts (such as organic-ammonium fluoride adducts) and combinations thereof. In addition, the cleaning chemistry can include one or more carrier solvents, such as N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate, and alcohols (such a methanol, ethanol and 2-propanol).

Further details of fluoride sources and methods of generating supercritical processing solutions with fluoride sources are described in U.S. patent application Ser. No. 10/442,557, filed May 20, 2003, and titled “TETRA-ORGANIC AMMONIUM FLUORIDE AND HF IN SUPERCRITICAL FLUID FOR PHOTORESIST AND RESIDUE REMOVAL”, and U.S. patent application Ser. No. 10/321,341, filed Dec. 16, 2002, and titled “FLUORIDE IN SUPERCRITICAL FLUID FOR PHOTORESIST POLYMER AND RESIDUE REMOVAL,” both incorporated by reference herein.

The chemistry supply system 230 can comprise a rinsing chemistry assembly (not shown) for providing rinsing chemistry for generating supercritical rinsing solutions within the processing chamber 208. The rinsing chemistry can include one or more carrier solvents, such as N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate, and alcohols (such a methanol, ethanol and 2-propanol).

As shown in FIG. 2, the carbon dioxide supply system 240 can be coupled to the processing module 210, but this is not required. In alternate embodiments, carbon dioxide supply system 240 can be configured differently and coupled differently. For example, the carbon dioxide supply system 240 can be coupled to the recirculation system 220.

The carbon dioxide supply system 240 can comprise a carbon dioxide source (not shown) and a plurality of flow control elements (not shown) for generating a supercritical fluid. For example, the carbon dioxide source can include a CO₂ feed system, and the flow control elements can include supply lines, valves, filters, pumps, and heaters. The carbon dioxide supply system 240 can comprise an inlet valve (not shown) that is configured to open and close to allow or prevent a stream of supercritical carbon dioxide from flowing into the processing chamber 208. For example, the controller 280 can be used to determine fluid parameters such as pressure, temperature, process time, and flow rate.

The processing system 200 can also comprise a pressure control system 250. As shown in FIG. 2, the pressure control system 250 can be coupled to the processing module 210, but this is not required. In alternate embodiments, pressure control system 250 can be configured differently and coupled differently. The pressure control system 250 can include one or more pressure valves (not shown) for exhausting the processing chamber 208 and/or for regulating the pressure within the processing chamber 208. Alternately, the pressure control system 250 can also include one or more pumps (not shown). For example, one pump may be used to increase the pressure within the processing chamber, and another pump may be used to evacuate the processing chamber 208. In another embodiment, the pressure control system 250 can comprise means for sealing the processing chamber. In addition, the pressure control system 250 can comprise means for raising and lowering the substrate 205 and/or the chuck 218.

As shown in FIG. 2, the exhaust control system 260 can be coupled to the processing module 210, but this is not required. In alternate embodiments, exhaust control system 260 can be configured differently and coupled differently. The exhaust control system 260 can include an exhaust gas collection vessel (not shown) and can be used to remove contaminants from the processing fluid. Alternately, the exhaust control system 260 can be used to recycle the processing fluid.

Controller 280 can use pre-process data, process data, and post-process data. For example, pre-process data can be associated with an incoming substrate. This pre-process data can include lot data, batch data, run data, composition data, and history data. The pre-process data can be used to establish an input state for a wafer. Process data can include process parameters. Post processing data can be associated with a processed substrate.

The controller 280 can use the pre-process data to predict, select, or calculate a set of process parameters to use to process the substrate. For example, this predicted set of process parameters can be a first estimate of a process recipe. A process model can provide the relationship between one or more process recipe parameters or set points and one or more process results. A process recipe can include a multi-step process involving a set of process modules. Post-process data can be obtained at some point after the substrate has been processed. For example, post-process data can be obtained after a time delay that can vary from minutes to days. The controller 280 can compute a predicted state for the substrate 205 based on the pre-process data, the process characteristics, and a process model. For example, a cleaning rate model can be used along with a contaminant level to compute a predicted cleaning time. Alternately, a rinse rate model can be used along with a contaminant level to compute a processing time for a rinse process.

The controller 280 can comprise a database component (not shown) for storing input and output data.

In a supercritical cleaning/rinsing process, the desired process result can be a process result that is measurable using an optical measuring device (not shown). For example, the desired process result can be an amount of contaminant in a via or on the surface of a substrate. After each cleaning process run, the desired process result can be measured.

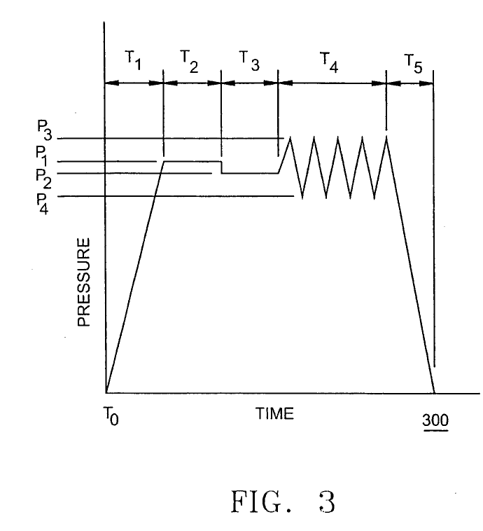

FIG. 3 illustrates an exemplary graph of pressure versus time for a supercritical process step in accordance with an embodiment of the invention. In the illustrated embodiment, a graph 300 is shown for a supercritical cleaning process step or a supercritical rinse process step. Alternately, different pressures, different timing, and different sequences may be used for different processes.

Now referring to both FIGS. 2 and 3, prior to an initial time To, the substrate with post-etch residue thereon can be placed within the processing chamber 208, and the processing chamber 208 can be sealed. The substrate and the processing chamber can be heated to an operational temperature. For example, the operational temperature can range from 40 to 300 degrees Centigrade.

From the initial time T₀ through a first duration of time T₁, the processing chamber 208 can be pressurized. In one embodiment, when the processing chamber 208 exceeds a critical pressure (1,070 psi), process chemistry can be injected into the processing chamber 208, using the process chemistry supply system 230. In alternate embodiments, process chemistry may be injected into the processing chamber 208 before the pressure exceeds the critical pressure Pc (1,070 psi) using the process chemistry supply system 230. For example, the injection(s) of the process chemistries can begin upon reaching about 1100-1200 psi. In other embodiments, process chemistry is not injected during the T₁ period.

In one embodiment, process chemistry is injected in a linear fashion. In other embodiments, process chemistry may be injected in a non-linear fashion. For example, process chemistry can be injected in one or more steps.

The process chemistry preferably includes a pyridine-HF adduct species, formed from a pyridine structure and hydrogen fluoride, that is injected into the system. One or more injections of process chemistries can be performed over the duration of time T₁ to generate a supercritical processing solution with the desired concentrations of chemicals. The process chemistry, in accordance with the embodiments of the invention, can also include one more or more carrier solvents, ammonium salts, hydrogen fluoride, and/or other sources of fluoride.

During a second time T₂, the supercritical processing solution can be re-circulated over the substrate and through the processing chamber 208 using the recirculation system 220, such as described above. In one embodiment, process chemistry is not injected during the second time T₂. Alternatively, process chemistry may be injected into the processing chamber 208 during the second time T₂ or after the second time T₂. The processing chamber 208 can operate at a pressure above 2,500 psi during the second time T₂. For example, the pressure can range from approximately 2,500 psi to approximately 3,100 psi, but can be any value so long as the operating pressure is sufficient to maintain supercritical conditions. The supercritical processing solution is circulated over the substrate and through the processing chamber 208 using the recirculation system 220, such as described above. Then the pressure within the processing chamber 208 is increased and over the duration of time, the supercritical processing solution continues to be circulated over the substrate 205 and through the processing chamber 208 using the recirculation system 220 and or the concentration of the supercritical processing solution within the processing chamber is adjusted by a push-through process, as described below.

Still referring to both FIGS. 2 and 3, during a third time T₃ a push-through process can be performed. During the third time T₃, a new quantity of supercritical carbon dioxide can be fed into the processing chamber 208 from the carbon dioxide supply system 240, and the supercritical cleaning solution along with process residue suspended or dissolved therein can be displaced from the processing chamber 208 through the exhaust control system 260. In addition, supercritical carbon dioxide can be fed into the recirculation system 220 from the carbon dioxide supply system 240, and the supercritical cleaning solution along with process residue suspended or dissolved therein can also be displaced from the recirculation system 220 through the exhaust control system 260.

After the push-through process is complete, a decompression process can be performed. In an alternate embodiment, a decompression process is not required. During a fourth time T₄, the processing chamber 208 can be cycled through a plurality of decompression and compression cycles. The pressure can be cycled between a first pressure P₃ and a second pressure P₄ one or more times. In alternate embodiments, the first pressure P₃ and a second pressure P₄ can vary. In one embodiment, the pressure can be lowered by venting through the exhaust control system 260. For example, this can be accomplished by lowering the pressure to below approximately 1,500 psi and raising the pressure to above approximately 2,500 psi. The pressure can be increased by adding high-pressure carbon dioxide.

During a fifth time T₅, the processing chamber 208 can be returned to lower pressure. For example, after the decompression and compression cycles are complete, then the processing chamber can be vented or exhausted to atmospheric pressure. For substrate processing, the chamber pressure can be made substantially equal to the pressure inside of a transfer chamber (not shown) coupled to the processing chamber 208. In one embodiment, the substrate 205 can be moved from the processing chamber 208 into the transfer chamber, and moved to a second process apparatus or module to continue processing.

The plot 300 is provided for exemplary purposes only. It will be understood by those skilled in the art that a supercritical processing step can have any number of different time/pressures or temperature profiles without departing from the scope of the invention. Further, any number of cleaning and rinse processing sequences with each step having any number of compression and decompression cycles are contemplated. In addition, as stated previously, concentrations of various chemicals and species within a supercritical processing solution can be readily tailored for the application at hand and altered at any time within a supercritical processing step.

In one embodiment, the cleaning step, such as described above, utilizes a supercritical cleaning solution comprising at least an amount of a fluoride adduct. The fluoride adduct is preferably formed form a pyridine and hydrogen fluoride. The supercritical cleaning solution also preferably comprises carbon dioxide and one solvent and is capable of removing the post-etch residue from a substrate with a low-k dielectric layer, as described in detail above.

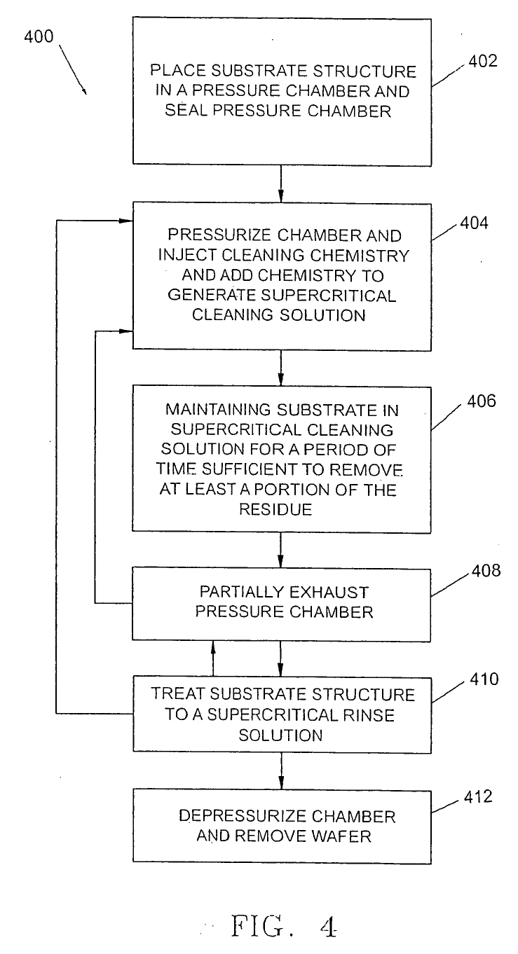

FIG. 4 shows a flow diagram 400 for a method of operating a processing system 200, in accordance with an embodiment of the invention. In the illustrated embodiment, steps for removing a post-etch residue from a substrate structure comprising a patterned low-k layer using a supercritical cleaning solution are shown. In the step 402, the substrate, including the post-etch residue, is placed and sealed within a processing chamber. In step 404, the processing chamber is pressurized with supercritical CO₂ and cleaning chemistry is added to the supercritical CO₂ to generate a supercritical cleaning solution. In one embodiment, the cleaning chemistry includes a pyridine structure and hydrogen fluoride. In one example, the pyridine structure and hydrogen fluoride are added separately to the supercritical CO₂, or in another example, the pyridine structure and hydrogen fluoride are pre-mixed and added as a pyridine-hydrogen fluoride adduct, described previously.

In step 406, the substrate is maintained in the supercritical cleaning solution for a duration of time sufficient to remove at least a portion of the residue from the substrate structure. During step 406, the supercritical cleaning solution is circulated through the processing chamber and/or otherwise agitated to move the supercritical cleaning solution over surfaces of the substrate structure.

Still referring to FIG. 4, after at least a portion of the residue is removed from the substrate structure in the step 406, the processing chamber is partially exhausted in the step 408. The cleaning process comprising steps 404 and 406 are repeated any number of times, as indicated by the arrow connecting the steps 408 to 404, required to remove a portion of the residue from the substrate structure.

In one embodiment, the cleaning process steps 404 and 406 use fresh supercritical carbon dioxide, fresh chemistry, or a combination thereof. Alternatively, the concentration of the cleaning chemistry may be modified by diluting the processing chamber with supercritical carbon dioxide, by adding additional charges of cleaning chemistry, or a combination thereof.

Still referring to FIG. 4, after the cleaning process or cycle comprising the steps 404, 406 and 408 is complete, in the step 410 the substrate structure is treated using a supercritical rinse solution. The supercritical rinse solution includes supercritical CO₂ and one or more co-solvents. Alternately, the supercritical rinse solution may include substantially pure supercritical CO₂.

In step 412, the processing chamber is depressurized and the substrate is removed from the processing chamber. Alternatively, the substrate is cycled through one or more additional cleaning/rinse processes comprising the steps 404, 406, 408, and 410 as indicated by the arrow connecting steps 410 and 404. Alternatively, or in addition to cycling the substrate through one or more additional cleaning/rinse cycles, the substrate may be treated to several rinse cycles prior to removing the substrate from the chamber in the step 412, as indicated by the arrow connecting the steps 410 and 408.

As described previously, the supercritical cleaning solution can also include one or more ammonium or fluoride sources and one or more carrier solvents. In addition, it will be clear to one skilled in the art that any number of different treatment sequences are within the scope of the invention. For example, cleaning steps and rinsing steps can be combined in any number of different ways to facilitate the removal of residue from a substrate.

### Experimental Results

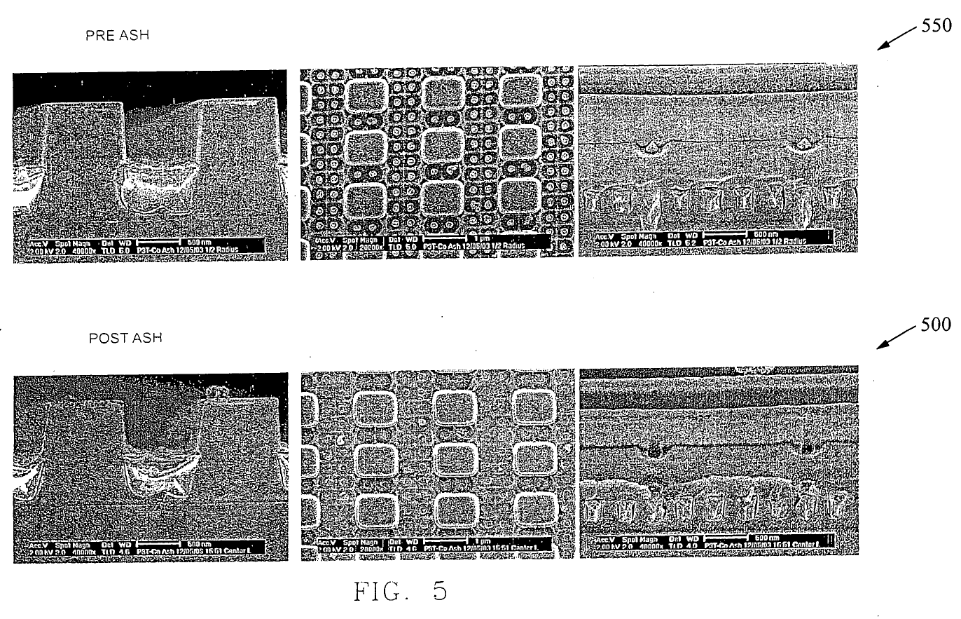

The supercritical processing system, such as described in detail above in reference to FIG. 2, was used to remove post-etch residue comprising siloxane-based material from a substrate comprising a patterned low-k layer, shown as 500 in FIG. 5. The substrate structure was placed in the processing chamber, the system temperature was adjusted to approximately 60 C., and an inlet valve for the carbon dioxide was opened to the processing chamber pressurizing the processing chamber to 1400 psi. Then, approximately 15 ml of N,N-dimethylacetamide and approximately 6 μl of hydrogen fluoride-pyridine adduct was injected into the processing chamber and was circulated through the processing chamber. After approximately 2 minutes, the pressure in the processing chamber was increased to approximately 3,000 psi by injecting additional carbon dioxide from the carbon dioxide supply system into the chamber. After approximately an additional 2 min, the processing chamber was subjected to a plurality of decompression and compression cycles, as explained in detail above. Finally, the processing chamber was vented to flush out the supercritical cleaning solution and the post-etch processing residue contained therein to complete the cleaning step. After the cleaning step was completed, a rinse step was performed by injecting approximately 15 ml of N,N-dimethylacetamide to the recirculation system (circulation loop) and pressurizing the processing chamber with supercritical carbon dioxide, cycling through a plurality of decompression and compression cycles essentially just described above for the cleaning step.

After the rinse step was completed, a SEM micrograph 550 of the treated wafer was taken, as shown in FIG. 5. A comparison the SEM micrographs of the wafer prior to treatment 500 and after treatment 550 shows that the supercritical cleaning solution comprising pyridine-hydrogen fluoride substantially removes post-etch residue from the substrate structure without causing damage to the patterned low-k carbon-doped-oxide (COD) layer therebelow.

As described previously, the supercritical cleaning solution utilized can also include one or more carrier solvents. In addition, it will be clear to one skilled in the art that any number of different treatment sequences are within the scope of the invention. For example, cleaning steps and rinsing steps can be combined in any number of different ways to achieve removal of a residue from a substrate.

The invention has the advantages of being sufficiently selective to remove post etch residues, including but not limited to spin-on polymeric anti-reflective coating layer and photopolymers, for patterned low-k dielectric layers without etching or attacking the patterned low-k silicon-based layer therebelow.

While the invention has been described in terms of specific embodiments incorporating details to facilitate the understanding of the principles of construction and operation of the invention, such reference herein to specific embodiments and details thereof is not intended to limit the scope of the claims appended hereto. It will be apparent to those skilled in the art that modifications may be made in the embodiments chosen for illustration without departing from the spirit and scope of the invention. Specifically, while supercritical CO₂ is the preferred medium for cleaning, other supercritical media alone or in combination with supercritical CO₂ are contemplated. Combination of various ammonium fluoride salts and hydrogen fluoride adducts can also be used as a source of anhydrous fluoride and/or hydrous fluoride in a supercritical cleaning solution. Further cleaning solutions with pyridine and hydrogen fluoride in combination with other anhydrous fluoride or organic fluoride for use in supercritical cleaning solutions are also contemplated.

What is claimed is:

1. A method of removing a siloxane-based polymer residue from a substrate structure, the method comprising:
maintaining the substrate structure in a supercritical cleaning solution comprising supercritical CO₂ and an amount of pyridine-hydrogen fluoride; and
removing the supercritical cleaning solution and the siloxane-based polymer residue away from the substrate structure.

2. The method of claim 1, wherein the cleaning solution further comprises a carrier solvent.

3. The method of claim 2, wherein the carrier solvent comprises N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate, or alcohol, or a combination of two or more thereof.

4. The method of claim 1, wherein the siloxane-based polymer residue comprises a sacrificial light-absorbing material (SLAM) polymer.

5. The method of claim 1, wherein the substrate structure comprises a low-k dielectric layer.

6. The method of claim 1, further comprising washing the substrate structure with a supercritical rinsing solution after removing the supercritical cleaning solution and the residue away from the substrate material.

7. The method of claim 6, wherein the supercritical rinsing solution comprises CO₂ and an organic solvent.

8. The method of claim 7, wherein the organic solvent comprises N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate, or alcohol, or a combination of two or more thereof.

9. A method for removing a residue from a substrate structure, the method comprising:
maintaining the substrate structure in a supercritical cleaning solution comprising supercritical CO2 and an amount of pyridine: hydrogen fluoride; and
removing the supercritical cleaning solution and the residue away from the substrate structure.

10. The method of claim 9, wherein the cleaning solution further comprises a carrier solvent.

11. The method of claim 1, wherein the carrier solvent is selected from the group consisting of N, N-dimethylacetamide (DMAC), gamma-butyrolacetone (BLO), dimethyl sulfoxide (DMSO), ethylene carbonate (EC), N-methylpyrrolidone (NMP), dimethylpiperidone, propylene carbonate and alcohol.

12. The method of claim 9, wherein the residue comprises a polymer.

13. The method of claim 12, wherein the polymer is a photoresist polymer.

14. The method of claim 13, wherein the photoresist polymer comprises an anti-reflective coating.

15. The method of claim 14, wherein the substrate structure comprises a low-k dielectric layer.

16 The method of claim 15, wherein the low-k dielectric layer comprises silicon oxide.

17. The method of claim 16, wherein the low-k dielectric layer comprises a material selected form the group consisting of a carbon doped oxide (COD), a spin-on-glass (SOG) and fluoridated silicon glass (FSG).

18. The method of claim 17, wherein the substrate structure further comprises an anti-reflective coating formed over the low-k dielectric layer.

19. The method of claim 18, wherein the anti-reflective coating comprises an organic spin-on anti-reflective material.

20. The method of claim 9, further comprising washing the substrate structure with a supercritical rinsing solution after removing the supercritical cleaning solution and the residue away from the substrate structure.

21. The method of claim 20, wherein the supercritical rinsing solution comprises CO2 and an organic solvent.
